(19) United States
(12) Patent Application Publication
(10) Pub. No.: US 2021/0142516 A1
(43) Pub. Date: May 13, 2021

(54) METHOD AND ELECTRONIC DEVICE FOR VIRTUAL INTERACTION

(71) Applicant: BEIJING DAJIA INTERNET INFORMATION TECHNOLOGY CO., LTD., Beijing (CN)

(72) Inventors: Liqian MA, Beijing (CN); Boning ZHANG, Beijing (CN); Guoxin ZHANG, Beijing (CN); Xuwei HUANG, Beijing (CN); Xiaoqiang LIU, Beijing (CN)

(21) Appl. No.: 17/096,793

(22) Filed: Nov. 12, 2020

(30) Foreign Application Priority Data
Nov. 12, 2019 (CN) 201911102972.0

(51) Int. Cl. G06T 7/73; G06T 7/246; G06T 19/00; G06K 9/00

(52) U.S. Cl. CPC G06T 7/75; G06T 7/246; G06K 9/00664; G06K 9/00255; G06T 19/006

(57) ABSTRACT

A method for virtual interaction belongs to the field of communication. The method can include: acquiring a virtual scene corresponding to a user group; acquiring user information of users in the user group, wherein the user information includes face orientation information of the users and first avatar location information of the users; updating display of avatars of the users in the virtual scene based on the user information; determining a display interface based on the face orientation information of a first user corresponding to the current electronic device and the first avatar location information of the first avatar, wherein the display interface includes a virtual scene with a perspective of the first user as an observation point; and displaying the display interface.

This application is based on and claims priority under 35 U.S.C. 119 to Chinese patent application No. 201911102972.0, filed on Nov. 12, 2019, in the China National Intellectual Property Administration, the disclosure of which is herein incorporated by reference in its entirety.

### TECHNICAL FIELD

The present disclosure relates to the field of a communication technology, in particular to a method for virtual interaction and an electronic device.

### BACKGROUND

With the continuous development of network video live streaming, users' demands for live streaming are getting higher and higher. For example, a user desires an immersive feeling in video live streaming. In order to achieve this demand, avatar-based live streaming has been proposed.

During the avatar-based live streaming, a display interface including a virtual scene can be displayed on a terminal side. However, terminals of users participating in the live streaming all display a display interface including the same virtual scene, resulting in relatively low authenticity of virtual interactions.

### SUMMARY

The present disclosure provides a method for virtual interaction and an electronic device.

According to a first aspect of embodiments of the present disclosure, a method for virtual interaction is provided. The method is applicable to an electronic device and includes: acquiring a virtual scene corresponding to a user group; acquiring user information of users in the user group, wherein the user information includes face orientation information of the users and first avatar location information of the users, the first avatar location information being latest location information of avatars of the users in the virtual scene; updating display of the avatars of the users in the virtual scene based on the user information; determining a display interface based on the face orientation information of a first user corresponding to the current electronic device and the first avatar location information of the first user, wherein the display interface includes a virtual scene with a perspective of the first user as an observation point; and displaying the display interface.

According to another aspect of embodiments of the present disclosure, an electronic device is provided. The electronic device includes: a processor; and a memory configured to store at least one computer program including at least one instruction executable by the processor, wherein the at least one instruction, when executed by the processor, causes the processor to perform a method including: acquiring a virtual scene corresponding to a user group; acquiring user information of users in the user group, wherein the user information includes face orientation information of the users and first avatar location information of the users, the first avatar location information being latest location information of avatars of the users in the virtual scene; updating display of the avatars of the users in the virtual scene based on the user information; determining a display interface based on the face orientation information of a first user corresponding to the current electronic device and the first avatar location information of the first user, wherein the display interface includes a virtual scene with a perspective of the first user as an observation point; and displaying the display interface.

According to yet another aspect of embodiments of the present disclosure, a storage medium storing at least one computer program including at least one instruction is provided. The at least one instruction, when executed by a processor of an electronic device, causes the electronic device to perform a method including: acquiring a virtual scene corresponding to a user group; acquiring user information of users in the user group, wherein the user information includes face orientation information of the users and first avatar location information of the users, the first avatar location information being latest location information of avatars of the users in the virtual scene; updating display of the avatars of the users in the virtual scene based on the user information; determining a display interface based on the face orientation information of a first user corresponding to the current electronic device and the first avatar location information of the first user, wherein the display interface includes a virtual scene with a perspective of the first user as an observation point; and displaying the display interface.

### BRIEF DESCRIPTION OF THE DRAWINGS

The accompanying drawings herein which are incorporated in and constitute a part of the description, illustrate the embodiments according to the present disclosure, and serve to explain the principles of the present disclosure together with the description, without constituting any improper limitation to the present disclosure.

FIG. 1 is a schematic diagram of a network architecture according to an example embodiment;

FIG. 2 is a flowchart of a creation process of a user group according to an example embodiment;

FIG. 3 is a flowchart of a method for adding the user group according to an example embodiment;

FIG. 4 is a flowchart of a method for virtual interaction according to an example embodiment;

FIG. 5 is a flowchart of another method for virtual interaction according to an example embodiment;

FIG. 6 is a block diagram of a virtual interaction apparatus according to an example embodiment;

FIG. 7 is a block diagram of another virtual interaction apparatus according to an example embodiment; and

FIG. 8 is a schematic structural diagram of an electronic device according to an example embodiment.

### DETAILED DESCRIPTION

In order to make those skilled in the art better understand the technical solutions of the present disclosure, the technical solutions in the embodiments of the present disclosure are clearly and completely described in the following with reference to the accompanying drawings.

It should be noted that the terms “first,” “second” and the like in the description and claims, as well as the above-mentioned drawings, of the present disclosure are used to distinguish similar objects, but not necessarily used to describe a specific order or precedence order. It should be understood that data used in this way can be interchanged where appropriate such that the embodiments of the present disclosure described herein can be practiced in a sequence other than those illustrated or described herein. The embodiments set forth in the following description of example embodiments do not represent all embodiments consistent with the present disclosure. Instead, they are merely examples of apparatuses and methods consistent with aspects related to the present disclosure as recited in the appended claims.

User information involved in the present disclosure is information authorized by a user or fully authorized by all parties.

Referring to FIG. 1, an embodiment of the present disclosure provides a network architecture, wherein the network architecture includes a server and electronic devices corresponding to users in a user group created by the server.

The user group includes a plurality of users. The electronic device corresponding to each of the plurality of users can display a display interface including a virtual scene corresponding to the user group. In some embodiments, the display interface including the virtual scene corresponding to the user group is also referred to as a first display interface corresponding to the user group. The virtual scene corresponding to the user group is configured to display avatars of the users in the user group. That is, the first display interface is configured to display the avatar of each user.

In some embodiments, the user group refers to a user group participating in a video conference, a user group in a live video room, or the like. The electronic device corresponding to the user includes a virtual reality (VR) sensor, and the like.

For any user in the user group, the electronic device corresponding to the any user can periodically collect user information of the any user, and send the user information of the any user to the server that creates this user group.

The server receives the user information of the users in the user group. For any user in the user group, the user information of each user in a most recently received user set is sent to the electronic device corresponding to the any user, wherein the user set includes all other users in the user group except for the any user.

The electronic device corresponding to the any user updates the display of the avatars of the user in a virtual scene based on the user information of the users, determines a display interface including a virtual scene with a perspective of the any user as an observation point based on the user information of the any user, and displays the display interface. In some embodiments, the process of updating the display of the avatars of the users in the virtual scene can be regarded as a process of driving the avatars of the users in the first display interface. The display interface that includes the virtual scene with the perspective of the any user as an observation point is also referred to as a second display interface. That is, the electronic device corresponding to any user drives the avatar of the any user in the first display interface based on the user information of the any user, drives the avatars of the users in the user set in the first display interface based on the user information of the users in the user set, convert the first display interface into the second display interface whose display perspective is the same as a viewing perspective of any user based on the user information of the any user, and displays the second display interface.

FIG. 2 is a flowchart showing a creation process of a user group according to an example embodiment. As shown in FIG. 2, this method is applicable to the network architecture shown in FIG. 1. An executive subject of this method is a first device corresponding to a first user. The first user is a user who creates the user group. This method includes the following steps.

In 201, the first device acquires a first display interface corresponding to a user group to be created, image configuration information of the first user, and initial user information of the first user, wherein the first device is an electronic device corresponding to the first user.

The first user is a user who creates the user group. The initial user information of the first user includes initial avatar location information of the first user, and initial avatar orientation information of the first user. The initial avatar location information of the first user refers to initial location information of the avatar of the first user in the first display interface. The initial avatar orientation information of the first user refers to initial orientation information of the avatar of the first user in the first display interface. The image configuration information of the first user includes the avatar of the first user and a size of an area occupied by the avatar of the first user. The size of the area occupied by the avatar of the first user refers to a size of an area occupied by the avatar of the first user in the first display interface.

The first display interface is a three dimensional (3D) space. The first display interface is also referred to as a virtual environment. The first display interface is configured to display the avatars of the users in the user group. The first display interface includes a movable plane and a sky box. The movable plane is a platform that carries the avatars of the users in the user group. The sky box is a background of the first display interface. In some embodiments, the sky box is a background image.

In some embodiments, the first device can acquire the first display interface.

The first user can select a background image of a display interface when creating the user group, and the first device acquires the selected background image, and generates the first display interface of the user group based on the selected background image. During practice, the first device can download background images of different styles from a server, and display the background images of different styles for the first user. The first user can select background image of any style. The first device acquires the background image of the selected style, and generates the first display interface of the user group based on the background image of the selected style. Alternatively, the first user has created other user groups before, and the server has saved a user ID of the first user and a display interface corresponding to the user group created previously by the first user in a corresponding relationship between the user ID and the display interface. The first device acquires the corresponding display interface from the server based on the user ID of the first user as the first display interface of the user group.

The image configuration information of the first user includes the avatar of the first user and the size of the area occupied by the avatar of the first user. The process of acquiring the image configuration information of the first user is the process of acquiring the avatar of the first user and the size of the area occupied by the avatar of the first user. In some embodiments, the first device can acquire the image configuration information of the first user.

The first device acquires image information of the first user, wherein the image information of the first user includes information such as a face shape, a chin shape, sizes of the eyes, a shape and color of the hair, a contour and size of the body, and matching clothing of the avatar.

In some embodiments, in the process of creating the user group by the first user, the first device can collect body information of the first user, wherein the body information includes a face shape, a hairstyle, a hair color, a chin shape, clothing, a contour and size of the body of the first user. The first device acquires image information matching the body information of the first user as the image information of the first user. Alternatively, the first device displays the matched image information, such that the first user can modify the image information and acquire the modified image information as the image information of the first user. Alternatively, the first user has created other user groups before, and the first device has saved the image information acquired when the first user creates the user group previously, such that the first device can acquire the saved image information as the image information of the first user.

After acquiring the image information of the first user, the first device generates an avatar of the first user based on the image information of the first user and determines a size of an area occupied by the avatar of the first user in the first display interface.

In some embodiments, the image information of the first user includes a body size of the avatar. The body size of the avatar can reflect at least one of a waist line, a bust, or a hip circumference of the avatar. The first device can determine a radius or diameter of a space area occupied by the avatar of the first user in the first display interface based on the body size of the avatar, and acquire the size of the area occupied by the avatar of the first user in the first display interface.

The initial user information of the first user includes initial avatar location information of the first user and initial avatar orientation information of the first user. Next, the processes of acquiring the initial avatar location information of the first user and acquiring the initial avatar orientation information of the first user by the first device are introduced, respectively.

In some embodiments, the first device can acquire the initial avatar location information of the first user. The first device randomly selects a location in the movable plane of the first display interface as the initial avatar location information of the first user or selects a preset location as the initial avatar location information of the first user. For example, the preset location is a center location of the movable plane, etc.

In some embodiments, the movable plane is divided into a plurality of grids. One grid is randomly selected from the movable plane, and location information corresponding to this grid is used as the initial avatar location information of the first user. Alternatively, a preset grid is selected, and location information corresponding to the preset grid is used as the initial avatar location information of the first user. For example, the preset grid is a center grid of the movable plane.

In some embodiments, the first device can acquire the initial avatar orientation information. The first device uses the preset orientation information as the initial avatar orientation information of the first user. For example, the initial avatar orientation information of the first user includes at least one of face orientation information and body orientation information of the first user.

In 202, the first device sends a creation request to the server, wherein the creation request includes the first display interface of the user group, the user ID of the first user, the image configuration information of the first user, and the initial user information of the first user.

The creation request is configured to request the server to create the user group. For details of the process of creating the user group by the server, reference may be made to the following embodiment shown in FIG. 5.

In some embodiments, the first device displays the avatar of the first user in the first display interface based on the initial avatar location information of the first user, the initial avatar orientation information of the first user, and the size of the area occupied by the avatar of the first user. During practice, in the first display interface, the first device determines the area occupied by the avatar of the first user based on the location information of the initial avatar of the first user and the size of the area occupied by the avatar of the first user, and displays the avatar of the first user in this area based on the initial avatar orientation information of the first user.

After the first user creates the user group, other users can join this user group. With respect to any other user who needs to join this user group, for convenience of description, the any other user is referred to as a second user. Referring to FIG. 3, FIG. 3 is a flowchart of a method for adding the user group according to an example embodiment.

In 301, a second device sends an acquisition request to the server, wherein the acquisition request includes a group ID of this user group.

The second device refers to an electronic device corresponding to the second user. The second device can acquire a group ID of each user group in the server. When the second user needs to join a user group, the second user may select the user group, and the second device acquires a group ID of the user group selected by the second user.

The acquisition request is configured to request the server to acquire and send the first display interface corresponding to the user group, image configuration information of n users currently existing in the user group, and user information of n users, wherein n is an integer greater than 0.

In 302, the second device receives the first display interface corresponding to the user group, the image configuration information of n users in the user group, and the user information of the n users; and acquires image configuration information of the second user.

The image configuration information of the second user includes an avatar of the second user and a size of an area occupied by the avatar of the second user. The size of the area occupied by the avatar of the second user refers to a size of an area occupied by the avatar of the second user in the first display interface.

In some embodiments, the second device can acquire the image configuration information. The second device acquires the image information of the second user, generates the avatar of the second user based on the image information of the second user, and determines the size of the area occupied by the avatar of the second user.

In 303, the second device acquires initial user information of the second user based on the size of the area occupied by the avatar of the second user, the image configuration information of n users in the user group, and the user information of the n users.

The initial user information of the second user includes initial avatar location information of the second user, and initial avatar orientation information of the second user. The user information of the n users in the user group includes current avatar location information of the users. The avatar configuration information of the n users in the user group includes the size of the area occupied by the avatars of the users.

In some embodiments, the second device can determine the area occupied by the avatars of the users in the user group in the first display interface based on the current avatar location information of the users in the user group and the size of the area occupied by the avatars of the users, and then determine the remaining free area in the first display interface. The second device determines the initial avatar location information of the second user from the free area based on the following first formula based on the size of the area occupied by the avatar of the second user, the current avatar location information of the users in the user group, and the size of the area occupied by the avatars of the users.

The first formula is

$$\{ \begin{matrix}{P}^{′} = {arg min}_{P} [ {\sum }_{i = 0}^{n - 1} ( \vert \vert P - {P}_{i} \vert - d \vert ) ] \\ \vert P - {P}_{i} \vert > {B}_{i} + B \\ \vert P - {P}_{i} \vert = \sqrt{{( x - {x}_{i} )}^{2} + {( y - {y}_{i} )}^{2}}\end{matrix}$$

In the first formula, P′ is the initial avatar location information of the second user; P is any piece of location information in this free area, the location information being (x, y); Pᵢ is current avatar location information of an i^{th} user in the user group, the location information being (xᵢ, yᵢ); d is a preset distance configured to represent an ideal distance between avatars of any two users; Bᵢ is a size of an area occupied by an avatar of the i^{th} user; B is the size of the area occupied by the avatar of the second user; n is the number of users in the user group, n being an integer greater than 1.

Each piece of location information in the free area is substituted into the first formula. When a piece of location information satisfies a condition shown in the first formula, the location information is used as the initial avatar location information of the second user. That is, the location information P which satisfies the condition shown in the first formula is used as the initial avatar location information P′ of the second user.

The second device determines initial avatar orientation information of the second user based on the initial avatar location information of the second user and the current avatar location information of the users in the user group. In some embodiments, during the practice, the second device determines avatar location information satisfying a distance condition from the current avatar location information of the users based on the initial avatar location information of the second user and the current avatar location information of the users in the user group, a location indicated by the avatar location information satisfying the distance condition being the closest to a location indicated by the initial avatar location information of the second user; and acquires the initial avatar orientation information of the first user based on the initial avatar location information of the first user and the avatar location information satisfying the distance condition.

That is, the second device selects, from the current avatar location information of the users in the user group, the current avatar location information of the user that is closest to the location indicated by the initial avatar location information of the second user, and further determines the initial avatar orientation information of the second user based on the selected avatar location information and the initial avatar location information of the second user. In some embodiments, the initial avatar orientation information of the second user is determined based on the following second formula based on the selected avatar location information and the initial avatar location information of the second user.

The second formula is

$$\vec{v} = ( \frac{{x}^{′} - x}{\vert {P}^{′} - P \vert} , \frac{{y}^{′} - y}{\vert {P}^{′} - P \vert} )$$

In the second formula, \vec{v} is a vector representing the initial avatar orientation information of the second user; P is the initial avatar location information of the second user; P has coordinates of (x, y); P′ is the selected virtual avatar information; P′ has coordinates of (x′,y′).

In 304, the second device sends an addition request to the server, wherein the addition request includes the group ID of the user group, the user ID of the second user, the image configuration information of the second user, and the initial user information of the second user.

The addition request is configured to request the server to add the second user to the user group. For details of adding the second user to the user group by the server, reference may be made to the following embodiment shown in FIG. 5.

In some embodiments, the second device displays the avatar of the second user in the first display interface based on the initial user information of the second user and the image configuration information of the second user; and displays the avatars of the users in the user group in the first display interface based on the user information of the users in the user group and the image configuration information of the users.

In some embodiments, the second device determines the area occupied by the avatar of the second user in the first display interface based on the initial avatar location information of the second user and the size of the area occupied by the avatar of the second user, and displays the avatar of the second user in this area based on the initial avatar orientation information of the second user. The second device determines the area occupied by the users in the first display interface based on the current avatar location information of the users in the user group and the size of the area occupied by the avatars of the users, and displays the avatars of the user in the user group in this area based on the initial avatar orientation information of the users.

For any user that has joined the user group, the user can perform virtual interactions in the user group, such as video live streaming.

FIG. 4 is a flowchart of a method for virtual interaction shown in an example embodiment. In this method, for any user in a user group, for convenience of description, the any user is referred to as a first user which can interact with other users in the user group. It should be noted that the first user in this embodiment may be the same user as the first user in the embodiment shown in FIG. 2 (that is, the user who creates the user group), or may also be a different user from the first user in the embodiment shown in FIG. 2. Referring to FIG. 4, an executive subject for the method for virtual interaction is the current electronic device. In some embodiments, the current electronic device refers to a first device corresponding to the first user. The method for virtual interaction includes the following steps.

In 401, a first device acquires a virtual scene corresponding to the user group.

In some embodiments, in the case that the first user is the user who creates the user group, the first device can locally acquire a virtual scene corresponding to the user group. The process of locally acquiring the virtual scene corresponding to the user group may refer to the process of acquiring the first display interface (that is, the virtual scene corresponding to the user group) by the first device as described in the embodiment shown in FIG. 2, which is not described herein any further.

In some embodiments, in the case that the first user is not a user who creates a user group, after the first user joins the user group, a server may send a virtual scene corresponding to the user group to the first device. Therefore, the first device acquires the virtual scene corresponding to the user group.

In some embodiments, in the case that the first user is not a user who creates a user group, the first user joins the user group by sending the image configuration information of the first user, the initial avatar location information of the first user, and the initial avatar orientation information of the first user to the server. The process of the first user to join the user group may refer to the process of the second user to join the user group as described in the embodiment shown in FIG. 3, which is not repeated herein.

In 402, the first device acquires user information of users in the user group, wherein the user information includes face orientation information of the users and first avatar location information of the users, the first avatar location information being latest location information of avatars of the users in the virtual scene.

In some embodiments, the user information also includes at least one of sound information of the users, facial expression information of the users, action information of the users, and body orientation information of the users. In some embodiments, the user information of the users includes user information of the first user and user information of the users in a user set. The user set includes all other users in the user group except for the first user.

In some embodiments, the first device acquires the user information of the first user. The user information of the first user includes at least one of sound information of the first user, facial expression information of the first user, action information of the first user and body orientation information of the first user, as well as the first avatar location information of the first user and the face orientation information of the first user.

With respect to the first avatar location information of the first user, the first device can collect a current spatial location of the first user, and determine whether the spatial location of the first user has changed based on the saved spatial location collected previously and the current spatial location. When it is determined that the spatial location of the first user has changed, the first device determines a movement distance of the first user and a movement direction of the first user based on the saved spatial location collected previously and the current spatial location. The first avatar location information of the avatar of the first user in the first display interface is determined based on the second avatar location information of the first user, second virtual location information of other users in the user group, the movement distance of the first user, and the movement direction of the first user. The second avatar location information of the first user is previously acquired location information of the avatar of the first user in the first display interface. The second avatar location information of other users is previously acquired location information of avatars of other users in the first display interface.

The first device also replaces the saved spatial location collected previously with the current spatial location.

When it is determined that the spatial location of the first user has not changed, the first device directly uses the previously acquired second avatar location information of the avatar of the first user in the first display interface as the first avatar location information of the first user directly.

The first device includes a VR sensor. The first device can collect the face orientation information of the first user, the facial expression information of the first user, the action information of the first user, or the body orientation information of the first user by using the VR sensor.

The first device includes a microphone or a sound sensor. The first device can collect sound information of the first user by using the microphone or the sound sensor.

The face orientation information of the first user includes a pitch angle, a yaw angle, and a roll angle of the first user's face in a world coordinate system.

In some embodiments, after acquiring the user information of the first user, the first device sends the group ID of the user group, the user ID of the first user, and the user information of the first user to the server.

For an electronic device corresponding to each of other users in the user group, this electronic device collects user information of the other users, and sends the group ID of the user group, user IDs of the other users, and user information of the other users to the server.

In some embodiments, the first device receives the user information of the users in the user set sent by the server. For the first user, the server periodically acquires most recently received user information of the users in the user set, and sends the user information of the users in the user set to the first device, wherein the user set includes all other users in the user group except for the first user.

The user information of the users in the user set includes at least one of sound information of the user, facial expression information of the user, action information of the user and body orientation information of the user, as well as first avatar location information of the user and face orientation information of the user.

In 403, the first device updates the display of the avatars of the users in the virtual scene based on the user information.

In some embodiments, the virtual scene corresponding to the user group is also referred to as the first display interface corresponding to the user group. The first device can update the display of the avatars of the users in the virtual scene based on the user information. The first device drives the avatar of the first user in the first display interface based on the user information of the first user; and drives the avatars of the users in the user set in the first display interface based on user information of the users in the user set.

In some embodiments, the first device can drive the avatar of the first user in the first display interface based on the user information of the first user. The first device determines the area occupied by the avatar of the first user in the first display interface based on the first avatar location information of the first user and the size of the area occupied by the first avatar, the first device displays the avatar of the first user in this area based on at least one of the facial expression information of the first user, the action information of the first user and the body orientation information of the first user, as well as the facial orientation information of the first user, and the first device can also play the sound information of the first user.

In the first display interface, a face orientation of the avatar of each user is the same as a direction indicated by the face orientation information of each user.

In 404, the first device determines a display interface based on the face orientation information of the first user and the first avatar location information of the first user, wherein the display interface includes a virtual scene with a perspective of the first user as an observation point; and displays the display interface.

In some embodiments, the display interface of the virtual scene with the perspective of the first user as the observation point is also referred to as a second display interface. The process of 404 is equivalent to a process of converting the first display interface by the first device based on the user information of the first user to obtain the second display interface, wherein a display perspective of the second display interface is the same as a viewing perspective of the first user. The user information of the first user includes at least the face orientation information of the first user and the first avatar location information of the first user.

In some embodiments, 404 may further comprise the following:

In 4041, a target coordinate system matching the perspective of the first user is constructed based on the face orientation information of the first user and the first avatar location information of the first user, wherein a direction of one coordinate axis of the target coordinate system is the same as a direction indicated by the face orientation information of the first user.

The construction process of the target coordinate system needs to determine a coordinate origin of the target coordinate system and three coordinate axes of the target coordinate system. In some embodiments, the constructing the target coordinate system matching can be performed by 4041A to 4041D as follows:

In 4041A, the first device determines the coordinate origin of the target coordinate system based on the first avatar location information of the first user.

In 4041B, the first device generates a face orientation vector based on a pitch angle and a yaw angle of the first user's face, and determines a first coordinate axis of the target coordinate system based on the face orientation vector.

A direction of the face orientation vector is the same as the orientation of the first user's face. For example, the way to determine the first coordinate axis of the target coordinate system based on the face orientation vector is as follows: a coordinate axis parallel to the face orientation vector is taken as the first coordinate axis of the target coordinate system.

In some embodiments, the face orientation vector is v₁=(−cos α·sin β, sin α, cos α·cos β), wherein α is the pitch angle, β and is the yaw angle.

In some embodiments, the first coordinate axis of the target coordinate system is a z axis of the target coordinate system.

In 4041C, the first device generates a first direction vector based on the roll angle of the first user's face, and determines a second coordinate axis of the target coordinate system based on the first direction vector.

In some embodiments, the coordinate axis parallel to the first direction vector is used as the second coordinate axis of the target coordinate system.

The first direction vector generated based on the roll angle is u₁=(sin(r), cos(r), 0), wherein r is the roll angle.

In some embodiments, the second coordinate axis of the target coordinate system is a y axis of the target coordinate system.

In 4041D, the first device generates a second direction vector based on the first direction vector and the face orientation vector, and determines a third coordinate axis of the target coordinate system based on the second direction vector.

In some embodiments, a coordinate axis parallel to the second direction vector is used as the third coordinate axis of the target coordinate system.

v₁ represents the face orientation vector; [symbol] ₁ represents the first direction vector; and the second direction vector generated based on the first direction vector and the face orientation vector is w₁=u₁×v₁.

In some embodiments, the third coordinate axis of the target coordinate system is an x axis of the target coordinate system.

The target coordinate system matching the perspective of the first user can be constructed according to the above operations from 4041A to 4041D. 4042 is then performed.

In 4042, the first device converts each pixel in the virtual scene to the target coordinate system, and determines a display interface including the converted virtual scene.

In some embodiments, the process of converting each pixel in the virtual scene to the target coordinate system is performed by 4042a and 4042b.

In 4042, the first device generates a spatial conversion matrix based on the first avatar location information, the face orientation vector, the first direction vector and the second direction vector of the first user, the spatial conversion matrix being configured to indicate a conversion relationship between the world coordinate system and the target coordinate system.

In some embodiments, the generated spatial conversion matrix

$$[ \begin{matrix}{w}_{1} & - {w}_{1} \cdot {P}_{1} \\ {u}_{1} & - {u}_{1} \cdot {P}_{1} \\ {v}_{1} & - {v}_{1} \cdot {P}_{1} \\ 0 & 1\end{matrix} ] .$$

In this spatial conversion matrix, P₁ is the first avatar location information of the first user; v₁ is the face orientation vector; [symbol] ₁ is the first direction vector; and [symbol] ₁ is the second direction vector.

In 4042b, the first device converts each pixel in the virtual scene to the target coordinate system based on the spatial conversion matrix.

After converting each pixel in the virtual scene to the target coordinate system based on the spatial conversion matrix, the first device determines a display interface including the converted virtual scene, wherein the display interface includes the converted virtual scene may also be referred to as a second display interface. That is, the first device converts each pixel in the first display interface to the target coordinate system based on the spatial conversion matrix and obtains the second display interface.

The electronic device corresponding to each user in the user set can acquire the second display interface by performing 401 to 404 in the same way as the first device, and display the obtained second display interface. Each electronic device can display a display interface that includes a virtual scene with the perspective of the user corresponding to the electronic device as an observation point.

In some embodiments, the first device collects the user information of the first user, and receives user information of the users in the user set sent by the server, wherein the user set includes other users in the user group except for the first user; drives the avatar of the first user in the first display interface based on the user information of the first user; and drives the avatars of the users in the user set in the first display interface based on the user information of the users in the user set. The first display interface is a display interface in the world coordinate system.

The first device then uses a location corresponding to the first avatar location information of the first user as the coordinate origin of the target coordinate system; generates the face orientation vector based on the pitch angle and the yaw angle of the first user's face, and takes the coordinate axis parallel to the face orientation vector as the z axis of the target coordinate system; generates the first direction vector based on the roll angle of the first user's face, and takes the coordinate axis parallel to the first direction vector as the y axis of the target coordinate system; generates the second direction vector based on the first direction vector and the face orientation vector, and takes the coordinate axis parallel to the second direction vector as the x axis of the target coordinate system. Therefore, the target coordinate system matching the perspective of the first user is constructed.

The first device then generates the spatial conversion matrix based on the first avatar location information, the face orientation vector, the first direction vector and the second direction vector of the first user, and converts each pixel in the first display interface to the target coordinate system based on the space conversion matrix, thereby obtaining the second display interface. Therefore, the display perspective of the second display interface is consistent with the face orientation of the first user, that is, consistent with the viewing perspective of the first user. In addition, the user information also includes at least one of the facial expression information, action information, body orientation information and the like of the user, such that the avatar driven based on the user information may change with user's facial expression, limbs or body. The user information also includes user sound information, such that the first device can also play the sound information.

FIG. 5 is a flowchart of a method for virtual interaction according to an example embodiment. As shown in FIG. 5, the method for virtual interaction is applicable to a network architecture shown in FIG. 1. An executive subject of the method for virtual interaction is a server. The method for virtual interaction includes the following steps.

In 501, the server creates a user group. An electronic device corresponding to a user in the user group includes a first display interface corresponding to the user group, wherein the first display interface includes an avatar corresponding to the user in the user group.

In 501, the server receives a creation request, the creation request including the first display interface corresponding to the user group, the user ID of the first user, the image configuration information of the first user, and the user information of the first user. A group ID is assigned to the user group. The first display interface of the user group, the user ID of the first user, the image configuration information of the first user, and the user information of the first user included in the creation request are saved. In this way, the user group is created.

The server can receive the creation request sent by the first device corresponding to the first user, the first user being a user requesting to create the user group. For details of sending the creation request by the first device, reference may be made to the related content in the embodiment shown in FIG. 2, which is not described in detail herein.

In 501, the server correspondingly saves the group ID and the first display interface in a corresponding relationship between the group ID and the display interface, and correspondingly saves the group ID, the user ID of the first user, and the image configuration information of the first user in a corresponding relationship among the group ID, the user ID and the image configuration information. The group ID, the user ID of the first user and the user information of the first user are correspondingly saved in the corresponding relationship among the group ID, the user ID and the user information.

After executing 501, the server can also perform the following operations 5011 to 5014 to allow users except for the first user to join the user group. The operations of 5011 to 5014 are as follows, respectively.

In 5011, the server receives an acquisition request sent by a second device, the acquisition request including the group ID of the user group; and send the first display interface corresponding to the user group, the image configuration information of the users currently existing in the user group, and the user information of the users to the second device based on the acquisition request.

The second device is an electronic device corresponding to a second user, and the second user is any user who needs to join the user group.

In some embodiments, the server acquires the first display interface corresponding to the user group from the corresponding relationship between the group ID and the display interface based on the group ID of the user group carried in the acquisition request. The image configuration information of the users in the user group is acquired based on the group ID of the user group from the corresponding relationship among the group ID, the user ID and the image configuration information. The user information of the users in the user group is acquired based on the group ID of the user group from the corresponding relationship among the group ID, the user ID and the user information. The server sends the first display interface corresponding to the user group, the image configuration information of the users in the user group, and the user information of the users to the second device.

In 5012, the server receives the addition request sent by the second device, the addition request including the group ID of the user group, the user ID of the second user, the image configuration information of the second user, and the initial user information of the second user.

After receiving the first display interface corresponding to the user group, the image configuration information of the users in the user group and the user information of the users, the second device acquires the image configuration information of the second user and the initial user information of the second user, and then sends the addition request to the server. For details of acquiring the image configuration information of the second user and the initial user information of the second user by the second device, reference may be made to the related content in the embodiment shown in FIG. 3, which is not described in detail herein.

In 5013, the server sends the initial user information of the second user and the image configuration information of the second user to the electronic device corresponding to each of n users in the user group, wherein the n users are users currently included in the user group, and n is an integer greater than or equal to 1.

The image configuration information of the second user includes an avatar of the second user and a size of an area occupied by the avatar of the second user. The electronic device corresponding to each of the n users displays the avatar of the second user in the first display interface based on the user information of the second user and a size of an area occupied by the avatar of the second user.

In 5014, the server saves the group ID of the user group, the user ID of the second user, the image configuration information of the second user, and the initial user information of the second user included in the addition request.

In some embodiments, after receiving the addition request, the server correspondingly saves the group ID, the user ID of the second user, and the image configuration information of the second user in the corresponding relationship among the group ID, the user ID and the image configuration information. The group ID, the user ID of the second user and the user information of the second user are correspondingly saved in the corresponding relationship among the group ID, the user ID, and the user information.

In 502, the server receives user information of the users in the user group.

In some embodiments, the server receives the group ID of the user group, the user ID of the users in the user group, and the user information of the users.

For the electronic device corresponding to any user in the user group, this electronic device can collect user information of the any user, and sends the group ID of the user group, a user ID of the any user, and user information of the any user to the server. Therefore, the server receives the group ID of the user group, the user ID of the any user, and the user information of the any user. The user information of the any user is updated to as the received user information based on the group ID of the user group and the user ID of the any user in the corresponding relationship among the group ID, the user ID and the user information. In this way, only the user information most recently sent by the electronic device corresponding to the any user is saved in the server, which can reduce storage resources occupying the server.

In 503, for any user in the user group, the server acquires most recently received user information of the users in the user set, and sends the user information of the users in the user set to the first device corresponding to the any user, wherein the user set includes all other users in the user group except for the any user.

The server can periodically acquire the user information of the users in the user group from the corresponding relationship among the group ID, the user ID and the user information. For any user, the server sends the user information of other users in the user group except for the any user to the electronic device corresponding to the any user.

The electronic device corresponding to the any user drives an avatar of the any user in the first display interface based on the user information of the any user; drives the avatars of the users in the user set in the first display interface based on the user information of the users in the user set; converts the first display interface into a second display interface whose display perspective is the same as a viewing perspective of the any user based on face orientation information of the any user in the user information of the any user and first avatar location information of the any user; and displays the second display interface. For details of performing the above process by the electronic device corresponding to the any user, reference may be made to the related content in the embodiment shown in FIG. 4, which is not described in detail herein.

In some embodiments, the server can receive the user information of each user in the user group; and send the most recently received user information of each user in the user set to the electronic device corresponding to any user in the user group, such that this device drives the avatar of the any user in the first display interface based on the user information of the any user, drives the avatars of the users in the user set in the first display interface based on the user information of the users in the user set, converts the first display interface into a second display interface whose display perspective is the same as a viewing perspective of the any user based on face orientation information of the any user in the user information of the any user and first avatar location information of the any user, and displays the second display interface in the electronic device corresponding to the any user.

FIG. 6 is a block diagram of a virtual interaction apparatus 600 according to an example embodiment. Referring to FIG. 6, the apparatus 600 can be deployed in the server in any of the above embodiments. The apparatus includes a creating unit 601, a receiving unit 602, and a sending unit 603.

The creating unit 601 is configured to create a user group, wherein the user group includes a plurality of users. An electronic device corresponding to each of the plurality of users includes a first display interface corresponding to the user group, wherein the first display interface includes an avatar corresponding to each user.

The receiving unit 602 is configured to receive user information of the users in the user group, wherein the user information of the users includes first avatar location information of the users and face orientation information of the users.

The sending unit 603 is configured to send most recently received user information of the users in a user set to the electronic device corresponding to any user in the user group, wherein the user set includes other users in the user group except for the any user. Therefore, the electronic device corresponding to the any user drives an avatar of the any user in the first display interface of the user group based on the user information of the any user; drives the avatars of the users in the user set in the first display interface of the user group based on the user information of the users in the user set; converts the first display interface into a second display interface whose display perspective is the same as a viewing perspective of the any user based on the face orientation information of the any user in the user information of the any user and the first avatar location information of the any user; and displays the second display interface.

In some embodiments, the sending unit 603 is further configured to send the first display interface, the user information of the users in the user group, and the image configuration information of the users to the electronic device corresponding to a user to be added.

The receiving unit 602 is further configured to receive an addition request sent by the electronic device corresponding to the user to be added, wherein the addition request includes the image configuration information of the user to be added and initial user information of the user to be added.

The sending unit 603 is further configured to send the initial user information of the user to be added and the image configuration information of the user to be added to an electronic device corresponding to any user.

In some embodiments, the user information of the users also includes at least one of sound information of the users, facial expression information of the users, action information of the users, and body orientation information of the users.

In some embodiments, the receiving unit receives the user information of the users in the user group. For any user in the user group, the sending unit sends the most recently received user information of the users in the user set to the electronic device corresponding to any user in the user group, wherein the user set includes other users in the user group except for the any user. Therefore, the electronic device drives the avatar of the any user in the first display interface corresponding to the user group based on the user information of the any user; drives the avatars of the users in the user set in the first display interface corresponding to the user group based on the user information of the users in the user set; converts the first display interface into a second display interface whose display perspective is the same as a viewing perspective of any user based on the face orientation information of the any user in the user information of the any user and the first location information of the avatar of the any user; and displays the second display interface.

FIG. 7 shows a virtual interaction apparatus 700 according to an example embodiment. Referring to FIG. 7, the apparatus 700 can be deployed in an electronic device. The apparatus includes an acquiring unit 701, a driving unit 702, a determining unit 703, and a displaying unit 704.

The acquiring unit 701 is configured to acquire a virtual scene corresponding to a user group.

The acquiring unit 701 is configured to acquire user information of users in the user group, wherein the user information includes face orientation information of the users and first avatar location information of the users, the first avatar location information being latest location information of avatars of the users in the virtual scene.

The updating unit 702 is configured to update display of the avatars of the users in the virtual scene based on the user information.

The determining unit 703 is configured to determine a display interface based on face orientation information of a first user corresponding to the current electronic device and the first avatar location information of the first user, wherein the display interface includes a virtual scene with a perspective of the first user as an observation point.

The displaying unit 704 is configured to display the display interface.

In some embodiments, the first user joins the user group by sending image configuration information of the first user, initial avatar location information of the first user, and initial avatar orientation information of the first user to a server.

In some embodiments, the image configuration information of the first user includes the avatar of the first user and a size of an area occupied by the avatar of the first user; the initial avatar location information of the first user is determined based on the size of the area occupied by the avatar of the first user, the current avatar location information of at least one user in the user group, and a size of an area occupied by the avatar of the at least one user; the initial avatar orientation information of the first user is determined based on the initial avatar location information of the first user and avatar location information satisfying a distance condition, wherein the avatar location information satisfying the distance condition is determined in the current avatar location information of the at least one user, and a location indicated by the avatar location information satisfying the distance condition is closest to a location indicated by the initial avatar location information of the first user.

In some embodiments, the first avatar location information of the first user is determined based on a movement distance of the first user, a movement direction of the first user, previously acquired second avatar location information of the first user, and previously acquired second avatar location information of other users in the user group. The movement distance of the first user and the movement direction of the first user are determined based on a previously collected spatial location of the first user and a current spatial location of the first user.

In some embodiments, the determining unit 703 is configured to: construct a target coordinate system matching a perspective of the first user based on the face orientation information of the first user and the first avatar location information of the first user, wherein a direction of one coordinate axis of the target coordinate system is the same as a direction indicated by the face orientation information of the first user; convert each pixel in the virtual scene to the target coordinate system; and determine a display boundary including the converted virtual scene.

In some embodiments, the face orientation information of the first user includes a pitch angle, a yaw angle and a roll angle of the first user's face in a world coordinate system; and the determining unit 703 is further configured to: determine a coordinate origin of the target coordinate system based on the first avatar location information of the first user; generate a face orientation vector based on the pitch angle and the yaw angle; determine a first coordinate axis of the target coordinate system based on the face orientation vector; generate a first direction vector based on the roll angle; determine a second coordinate axis of the target coordinate system based on the first direction vector; generate a second direction vector based on the first direction vector and the face orientation vector; and determine a third coordinate axis of the target coordinate system based on the second direction vector.

In some embodiments, the determining unit 703 is further configured to generate a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and convert each pixel in the virtual scene to the target coordinate system based on the spatial conversion matrix.

FIG. 8 illustrates a structural block diagram of an electronic device 800 according to an example embodiment. The electronic device 800 is an electronic device corresponding to a user in the user group in any of the above embodiments. In some embodiments, the electronic device 800 is a portable mobile terminal, such as a smart phone, a tablet computer, a notebook computer, or a desktop computer. In some embodiments, the electronic device 800 may also be referred to as user equipment, a portable terminal, a laptop terminal, a desktop terminal, or the like.

Generally, the electronic device 800 includes a processor 801 and a memory 802.

The processor 801 may include one or more processing cores, such as a 4-core processor, an 8-core processor, or the like. The processor 800 may be practiced in any one of hardware forms of a digital signal processor (DSP), a field-programmable gate array (FPGA), and a programmable logic array (PLA). The processor 801 may also include a main processor and a coprocessor. The main processor is a processor for processing the data in an awake state, and is also called a central processing unit (CPU). The coprocessor is a low-power-consumption processor for processing the data in a standby state. In some embodiments, the processor 801 may be integrated with a graphics processing unit (GPU), which is configured to render and draw the content that needs to be displayed by a display screen. In some embodiments, the processor 801 may also include an Artificial Intelligence (AI) processor configured to process computational operations related to machine learning.

The memory 802 may include one or more computer-readable storage media, which can be non-transitory. The memory 802 may also include a high-speed random access memory, as well as a non-volatile memory, such as one or more disk storage devices and flash storage devices. In some embodiments, the non-transitory computer-readable storage medium in the memory 802 is configured to store at least one instruction. The at least one instruction is configured to be executed by the processor 801 to perform the method for virtual interaction according to the method embodiments of the present disclosure.

In some embodiments, the terminal 800 also includes a peripheral device interface 803 and at least one peripheral device. The processor 801, the memory 802, and the peripheral device interface 803 may be connected by a bus or a signal line. Each peripheral device may be connected to the peripheral device interface 803 by a bus, a signal line, or a circuit board. In some embodiments, the peripheral device includes at least one of a radio frequency circuit 804, a display screen 805, a camera component 806, an audio circuit 807, a positioning component 808 and a power source 809.

The peripheral device interface 803 may be configured to connect at least one peripheral device associated with an input/output (I/O) to the processor 801 and the memory 802. In some embodiments, the processor 801, the memory 802 and the peripheral device interface 803 are integrated on the same chip or circuit board. In some other embodiments, any one or two of the processor 801, the memory 802 and the peripheral device interface 803 may be practiced on a separate chip or circuit board, which is not limited in this embodiment.

The radio frequency circuit 804 is configured to receive and transmit a radio frequency (RF) signal, which is also referred to as an electromagnetic signal. The radio frequency circuit 804 communicates with a communication network and other communication devices via the electromagnetic signal. The radio frequency circuit 804 converts an electrical signal into an electromagnetic signal for transmission, or converts the received electromagnetic signal into an electrical signal. In some embodiments, the radio frequency circuit 804 includes an antenna system, an RF transceiver, one or more amplifiers, a tuner, an oscillator, a digital signal processor, a codec chipset, a subscriber identity module card, and the like. The radio frequency circuit 804 can communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 804 may also include a near-field communication (NFC) related circuit, which is not limited in the present disclosure.

The display screen 805 is configured to display a user interface (UI). The UI may include graphics, text, icons, videos, and any combination thereof. When the display screen 805 is a touch display screen, the display screen 805 also has the capacity to acquire touch signals on or over the surface of the display screen 805. The touch signal may be input into the processor 801 as a control signal for processing. At this time, the display screen 805 may also be configured to provide virtual buttons and/or virtual keyboards, which are also referred to as soft buttons and/or soft keyboards. In some embodiments, one display screen 805 may be disposed on the front panel of the electronic device 800. In some embodiments, at least two display screens 805 may be disposed respectively on different surfaces of the electronic device 800 or in a folded design. In some embodiments, the display screen 805 may be a flexible display screen disposed on the curved or folded surface of the terminal 800. Even the display screen 805 may be provided with an irregular shape other than a rectangle; that is, the display screen 805 may be an irregular-shaped screen. In some embodiments, the display screen 805 may be prepared by a material, such as a liquid crystal display (LCD), an organic light-emitting diode (OLED) or the like.

The camera component 806 is configured to capture images or videos. In some embodiments, the camera component 806 includes a front camera and a rear camera. Usually, the front camera is placed on the front panel of the electronic device 800, and the rear camera is placed on the back of the electronic device 800. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and virtual reality (VR) shooting functions achieved by fusion of the main camera and the wide-angle camera or other fusion shooting functions. In some embodiments, the camera component 806 may also include a flashlight. The flashlight may be a mono-color temperature flashlight or a two-color temperature flashlight. The two-color temperature flash is a combination of a warm flashlight and a cold flashlight and can be used for light compensation at different color temperatures.

The audio circuit 807 may include a microphone and a speaker. The microphone is configured to collect sound waves of users and environments, and convert the sound waves into electrical signals which are input into the processor 801 for processing, or input into the RF circuit 804 for voice communication. For the purpose of stereo acquisition or noise reduction, there may be a plurality of microphones respectively disposed at different locations of the electronic device 800. The microphone may also be an array microphone or an omnidirectional acquisition microphone. The speaker is then configured to convert the electrical signals from the processor 801 or the radio frequency circuit 804 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 807 may also include a headphone jack.

The positioning component 808 is configured to locate the current geographic location of the electronic device 800 to implement navigation or a location based service (LBS). In some embodiments, the positioning component 808 may be the global positioning system (GPS) from the United States, the Beidou positioning system from China, the Grenas satellite positioning system from Russia or the Galileo satellite navigation system from the European Union.

The power source 809 is configured to power up various components in the electronic device 800. In some embodiments, the power source 809 may be alternating current, direct current, a disposable battery, or a rechargeable battery. When the power source 809 includes the rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may also support the fast charging technology.

In some embodiments, the electronic device 800 also includes one or more sensors 810. The one or more sensors 810 include, but not limited to, an acceleration sensor 811, a gyro sensor 812, a pressure sensor 813, a fingerprint sensor 814, an optical sensor 815, a proximity sensor 816, a VR sensor 817, and the like.

The acceleration sensor 811 may detect magnitudes of accelerations on three coordinate axes of a coordinate system established by the electronic device 800. For example, the acceleration sensor 811 may be configured to detect components of a gravitational acceleration on the three coordinate axes. The processor 801 may control the display screen 805 to display a user interface in a landscape view or a portrait view based on a gravity acceleration signal collected by the acceleration sensor 811. The acceleration sensor 811 may also be configured to collect motion data of a game or a user.

The gyro sensor 812 can detect a body direction and a rotation angle of the electronic device 800, and can cooperate with the acceleration sensor 811 to collect a 3D motion of the user on the electronic device 800. Based on the data collected by the gyro sensor 812, the processor 801 can serve the following functions: motion sensing (such as changing the UI based on a user's tilt operation), image stabilization during shooting, game control and inertial navigation.

The pressure sensor 813 may be disposed on a side frame of the electronic device 800 and/or a lower layer of the display screen 805. When the pressure sensor 813 is disposed on the side frame of the terminal 800, a user's holding signal to the terminal 800 can be detected. The processor 801 can perform left-right hand recognition or quick operation based on the holding signal collected by the pressure sensor 813. When the pressure sensor 813 is disposed on the lower layer of the display screen 805, the processor 801 controls an operable control on the UI based on a user's pressure operation on the display screen 805. The operable control includes at least one of a button control, a scroll bar control, an icon control and a menu control.

The fingerprint sensor 814 is configured to collect a user's fingerprint. The processor 801 identifies the user's identity based on the fingerprint collected by the fingerprint sensor 814, or the fingerprint sensor 814 identifies the user's identity based on the collected fingerprint. When the user's identity is identified as trusted, the processor 801 authorizes the user to perform related sensitive operations, such as unlocking the screen, viewing encrypted information, downloading software, paying, and changing settings. The fingerprint sensor 814 may be provided on the front, back, or side of the electronic device 800. When the electronic device 800 is provided with a physical button or a manufacturer's logo, the fingerprint sensor 814 may be integrated with the physical button or the manufacturer's logo.

The optical sensor 815 is configured to collect ambient light intensity. In some embodiments, the processor 801 may control the display brightness of the display screen 805 based on the ambient light intensity collected by the optical sensor 815. For example, when the ambient light intensity is high, the display brightness of the display screen 805 is increased; and when the ambient light intensity is low, the display brightness of the display screen 805 is decreased. In some embodiments, the processor 801 may also dynamically adjust shooting parameters of the camera component 806 based on the ambient light intensity collected by the optical sensor 815.

The proximity sensor 816, also referred to as a distance sensor, is usually disposed on the front panel of the electronic device 800. The proximity sensor 816 is configured to capture a distance between the user and a front surface of the electronic device 800. In some embodiments, when the proximity sensor 816 detects that the distance between the user and the front surface of the electronic device 800 becomes gradually smaller, the processor 801 controls the display screen 805 to switch from a screen-on state to a screen-off state; when the proximity sensor 816 detects that the distance between the user and the front surface of the electronic device 800 gradually increases, the processor 801 controls the display screen 805 to switch from the screen-off state to the screen-on state.

The VR sensor 817 collects a spatial location of a user in a world coordinate system, and collects face information and body information of the user.

It can be understood by those skilled in the art that the structure shown in FIG. 8 does not constitute a limitation to the electronic device 800. In some embodiments, the electronic device 800 may include more or less components than those illustrated, or combine some components or adopt different component arrangements.

An embodiment of the present disclosure provides an electronic device. The electronic device includes a processor and a memory configured to store at least one computer program including at least one instruction executable by the processor. The at least one computer program, when loaded and run by the processor, causes the processor to execute instructions for:

acquiring a virtual scene corresponding to a user group;

acquiring user information of users in the user group, wherein the user information includes face orientation information of the users and first avatar location information of the users, the first avatar location information being latest location information of avatars of the users in the virtual scene;

updating display of the avatars of the users in the virtual scene based on the user information;

determining a display interface based on the face orientation information of a first user corresponding to the current electronic device and the first avatar location information of the first user, wherein the display interface includes a virtual scene with a perspective of the first user as an observation point; and displaying the display interface.

In some embodiments, the first user joins the user group by sending image configuration information of the first user, initial avatar location information of the first user, and initial avatar orientation information of the first user to a server.

In some embodiments, the image configuration information of the first user includes the avatar of the first user and a size of an area occupied by the avatar of the first user. The initial avatar location information of the first user is determined based on the size of the area occupied by the avatar of the first user, the current avatar location information of at least one user in the user group, and a size of an area occupied by the avatar of the at least one user; the initial avatar orientation information of the first user is determined based on the initial avatar location information of the first user and avatar location information satisfying a distance condition, wherein the avatar location information satisfying the distance condition is determined in the current avatar location information of the at least one user, and a location indicated by the avatar location information satisfying the distance condition is closest to a location indicated by the initial avatar location information of the first user.

In some embodiments, the first avatar location information of the first user is determined based on a movement distance of the first user, a movement direction of the first user, previously acquired second avatar location information of the first user, and previously acquired second avatar location information of other users in the user group. The movement distance of the first user and the movement direction of the first user are determined based on a previously collected spatial location of the first user and a current spatial location of the first user.

In some embodiments, the at least one computer program, when loaded and run by the processor, causes the processor to execute instructions for:

constructing a target coordinate system matching the perspective of the first user based on the face orientation information of the first user and the first avatar location information of the first user, wherein a direction of one coordinate axis of the target coordinate system is the same as a direction indicated by the face orientation information of the first user;

converting each pixel in the virtual scene to the target coordinate system, and determining a display interface including the converted virtual scene.

In some embodiments, the face orientation information of the first user includes a pitch angle, a yaw angle and a roll angle of the first user's face in the world coordinate system; and the at least one computer program, when loaded and run by the processor, causes the processor to execute instructions for:

determining a coordinate origin of the target coordinate system based on the first avatar location information of the first user;

generating a face orientation vector based on a pitch angle and a yaw angle; and

determining a first coordinate axis of the target coordinate system based on the face orientation vector;

generating a first direction vector based on the roll angle; and determining a second coordinate axis of the target coordinate system based on the first direction vector; and

generating a second direction vector based on the first direction vector and the face orientation vector, and determining a third coordinate axis of the target coordinate system based on the second direction vector.

In some embodiments, the at least one computer program, when loaded and run by the processor, causes the processor to execute instructions for:

generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and

converting each pixel in the virtual scene to the target coordinate system based on the spatial conversion matrix.

An embodiment of the present disclosure provides a storage medium storing at least one computer program including at least one instruction. The at least one computer program, when loaded and run by a processor of an electronic device, causes the electronic device to execute instructions for:

acquiring a virtual scene corresponding to a user group;

acquiring user information of users in the user group, wherein the user information includes face orientation information of the users and first avatar location information of the users, the first avatar location information being latest location information of avatars of the users in the virtual scene;

updating display of the avatars of the users in the virtual scene based on the user information;

determining a display interface based on the face orientation information of a first user corresponding to the current electronic device and the first avatar location information of the first avatar, wherein the display interface includes a virtual scene with a perspective of the first user as an observation point; and displaying the display interface.

In some embodiments, the first user joins the user group by sending image configuration information of the first user, initial avatar location information of the first user, and initial avatar orientation information of the first user to a server.

In some embodiments, the image configuration information of the first user includes the avatar of the first user and a size of an area occupied by the avatar of the first user; the initial avatar location information of the first user is determined based on the size of the area occupied by the avatar of the first user, the current avatar location information of at least one user in the user group, and a size of an area occupied by the avatar of the at least one user; and the initial avatar orientation information of the first user is determined based on the initial avatar location information of the first user and avatar location information satisfying a distance condition, wherein the avatar location information satisfying the distance condition is determined in the current avatar location information of the at least one user, and a location indicated by the avatar location information satisfying the distance condition is closest to a location indicated by the initial avatar location information of the first user.

In some embodiments, the first avatar location information of the first user is determined based on a movement distance of the first user, a movement direction of the first user, previously acquired second avatar location information of the first user, and previously acquired second avatar location information of other users in the user group. The movement distance of the first user and the movement direction of the first user are determined based on a previously collected spatial location of the first user and a current spatial location of the first user.

In some embodiments, the at least one computer program, when loaded and run by the processor of the electronic device, causes the electronic device to execute instructions for:

constructing a target coordinate system matching the perspective of the first user based on the face orientation information of the first user and the first avatar location information of the first user, wherein a direction of one coordinate axis of the target coordinate system is the same as a direction indicated by the face orientation information of the first user;

converting each pixel in the virtual scene to the target coordinate system, and determining a display interface including the converted virtual scene.

In some embodiments, the face orientation information of the first user includes a pitch angle, a yaw angle and a roll angle of the first user's face in a world coordinate system; and the at least one computer program, when loaded and run by the processor of the electronic device, causes the electronic device to execute instructions for:

determining a coordinate origin of the target coordinate system based on the first avatar location information of the first user;

generating a face orientation vector based on the pitch angle and the yaw angle of the first user's face; and determining a first coordinate axis of the target coordinate system based on the face orientation vector;

generating a first direction vector based on the roll angle of the first user's face; and determining a second coordinate axis of the target coordinate system based on the first direction vector; and

generating a second direction vector based on the first direction vector and the face orientation vector, and determining a third coordinate axis of the target coordinate system based on the second direction vector.

In some embodiments, the at least one computer program, when loaded and run by the processor of the electronic device, causes the electronic device to execute instructions for:

generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and

converting each pixel in the virtual scene to the target coordinate system based on the spatial conversion matrix.

An embodiment of the present disclosure provides a computer program product. The computer program product, when loaded and run by an electronic device, causes the electronic device to execute instructions for:

acquiring a virtual scene corresponding to a user group;

acquiring user information of users in the user group, wherein the user information includes face orientation information of the users and first avatar location information of the users, the first avatar location information being the latest location information of avatars of the users in the virtual scene;

updating display of the avatars of the users in the virtual scene based on the user information;

determining a display interface based on the face orientation information of a first user corresponding to the current electronic device and the first avatar location information of the first user, wherein the display interface includes a virtual scene with a perspective of the first user as an observation point; and displaying the display interface.

In some embodiments, the first user joins the user group by sending image configuration information of the first user, initial avatar location information of the first user, and initial avatar orientation information of the first user to a server.

In some embodiments, the image configuration information of the first user includes the avatar of the first user and a size of an area occupied by the avatar of the first user; the initial avatar location information of the first user is determined based on the size of the area occupied by the avatar of the first user, the current avatar location information of at least one user in the user group, and a size of an area occupied by the avatar of the at least one user; and the initial avatar orientation information of the first user is determined based on the initial avatar location information of the first user and the avatar location information satisfying a distance condition, wherein the avatar location information satisfying the distance condition is determined in the current avatar location information of the at least one user, and a location indicated by the avatar location information satisfying the distance condition is closest to a location indicated by the initial avatar location information of the first user.

In some embodiments, the first avatar location information of the first user is determined based on a movement distance of the first user, a movement direction of the first user, previously acquired second avatar location information of the first user, and previously acquired second avatar location information of other users in the user group. The movement distance of the first user and the movement direction of the first user are determined based on a previously collected spatial location of the first user and a current spatial location of the first user.

In some embodiments, the computer program product, when loaded and run by the electronic device, causes the electronic device to execute instructions for:

constructing a target coordinate system matching the perspective of the first user based on the face orientation information of the first user and the first avatar location information of the first user, wherein a direction of one coordinate axis of the target coordinate system is the same as a direction indicated by the face orientation information of the first user; and

converting each pixel in the virtual scene to the target coordinate system, and determining a display interface including the converted virtual scene.

In some embodiments, the face orientation information of the first user includes a pitch angle, a yaw angle and a roll angle of the first user's face in a world coordinate system; and the computer program product, when loaded and run by the electronic device, causes the electronic device to execute instructions for:

determining a coordinate origin of the target coordinate system based on the first avatar location information of the first user;

generating a face orientation vector based on the pitch angle and the yaw angle; and determining a first coordinate axis of the target coordinate system based on the face orientation vector;

generating a first direction vector based on the roll angle; and determining a second coordinate axis of the target coordinate system based on the first direction vector; and

generating a second direction vector based on the first direction vector and the face orientation vector, and determining a third coordinate axis of the target coordinate system based on the second direction vector.

In some embodiments, the computer program product, when loaded and run by the electronic device, causes the electronic device to execute instructions for:

generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and

converting each pixel in the virtual scene to the target coordinate system based on the spatial conversion matrix.

An embodiment of the present disclosure provides a virtual interaction system. The system includes the apparatus in the embodiment shown in FIG. 6 and the apparatus in the embodiment shown in FIG. 7.

Other embodiments of the present disclosure will be apparent to those skilled in the art from consideration of the description and practice of the present disclosure. The present disclosure is intended to cover any variations, uses, or adaptations of the present disclosure following the general principles thereof and including common knowledge or commonly used technical measures which are not disclosed herein. The description and embodiments are to be considered as examples only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only subject to the appended claims.

What is claimed is:

1. A method for virtual interaction, which is applicable to an electronic device, the method comprising:
acquiring a virtual scene corresponding to a user group;
acquiring user information of users in the user group, wherein the user information comprises face orientation information of the users and first avatar location information of the users, the first avatar location information being latest location information of avatars of the users in the virtual scene;
updating display of the avatars of the users in the virtual scene based on the user information;
determining a display interface based on the face orientation information of a first user corresponding to a current electronic device and the first avatar location information of the first user, wherein the display interface comprises a virtual scene with a perspective of the first user as an observation point; and
displaying the display interface.

2. The method according to claim 1, wherein the first user joins the user group by sending image configuration information of the first user, initial avatar location information of the first user, and initial avatar orientation information of the first user to a server.

3. The method according to claim 2, wherein:
the image configuration information of the first user comprises the avatar of the first user and a size of an area occupied by the avatar of the first user;
the initial avatar location information of the first user is determined based on the size of the area occupied by the avatar of the first user, current avatar location information of at least one user in the user group, and a size of an area occupied by the avatar of the at least one user; and
the initial avatar orientation information of the first user is determined based on the initial avatar location information of the first user and avatar location information satisfying a distance condition; and
wherein the avatar location information satisfying the distance condition is determined in the current avatar location information of the at least one user, and a location indicated by the avatar location information satisfying the distance condition is closest to a location indicated by the initial avatar location information of the first user.

4. The method according to claim 1, wherein the first avatar location information of the first user is determined based on a movement distance of the first user, a movement direction of the first user, previously acquired second avatar location information of the first user, and previously acquired second avatar location information of other users in the user group, wherein the movement distance of the first user and the movement direction of the first user are determined based on a previously collected spatial location of the first user and a current spatial location of the first user.

5. The method according to claim 1, wherein said determining the display interface based on the face orientation information of the first user corresponding to the current electronic device and the first avatar location information of the first user comprises:
constructing a target coordinate system matching the perspective of the first user based on the face orientation information of the first user and the first avatar location information of the first user, wherein a direction of one coordinate axis of the target coordinate system is same as a direction indicated by the face orientation information of the first user; and
converting each pixel in the virtual scene to the target coordinate system, and determining a display interface comprising the converted virtual scene.

6. The method according to claim 5, wherein the face orientation information of the first user comprises a pitch angle, a yaw angle and a roll angle of the first user's face in a world coordinate system, and said constructing the target coordinate system comprises:
determining a coordinate origin of the target coordinate system based on the first avatar location information of the first user;
generating a face orientation vector based on the pitch angle and the yaw angle, and determining a first coordinate axis of the target coordinate system based on the face orientation vector;
generating a first direction vector based on the roll angle, and determining a second coordinate axis of the target coordinate system based on the first direction vector; and
generating a second direction vector based on the first direction vector and the face orientation vector, and determining a third coordinate axis of the target coordinate system based on the second direction vector.

7. The method according to claim 6, wherein said converting the each pixel in the virtual scene to the target coordinate system comprises:
generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and
converting the each pixel in the virtual scene to the target coordinate system based on the spatial conversion matrix.

8. An electronic device, comprising:
a processor; and
a memory configured to store at least one computer program comprising at least one instruction executable by the processor;
wherein the at least one instruction, when executed by the processor, causes the processor to perform a method comprising:
acquiring a virtual scene corresponding to a user group;
acquiring user information of users in the user group, wherein the user information comprises face orientation information of the users and first avatar location information of the users, the first avatar location information being latest location information of avatars of the users in the virtual scene;
updating display of the avatars of the users in the virtual scene based on the user information;
determining a display interface based on the face orientation information of a first user corresponding to a current electronic device and the first avatar location information of the first avatar, wherein the display interface comprises a virtual scene with a perspective of the first user as an observation point; and
displaying the display interface.

9. The electronic device according to claim 8, wherein the first user joins the user group by sending image configuration information of the first user, initial avatar location information of the first user, and initial avatar orientation information of the first user to a server.

10. The electronic device according to claim 9, wherein:
the image configuration information of the first user comprises the avatar of the first user and a size of an area occupied by the avatar of the first user;
the initial avatar location information of the first user is determined based on the size of the area occupied by the avatar of the first user, the current avatar location information of at least one user in the user group, and a size of an area occupied by the avatar of the at least one user; and
the initial avatar orientation information of the first user is determined based on the initial avatar location information of the first user and the avatar location information satisfying a distance condition; and
wherein the avatar location information satisfying the distance condition is determined in the current avatar location information of the at least one user, and a location indicated by the avatar location information satisfying the distance condition is closest to a location indicated by the initial avatar location information of the first user.

11. The electronic device according to claim 8, wherein the first avatar location information of the first user is determined based on a movement distance of the first user, a movement direction of the first user, previously acquired second avatar location information of the first user, and previously acquired second avatar location information of other users in the user group, wherein the movement distance of the first user and the movement direction of the first user are determined based on a previously collected spatial location of the first user and a current spatial location of the first user.

12. The electronic device according to claim 8, wherein said determining the display interface based on the face orientation information of the first user corresponding to the current electronic device and the first avatar location information of the first user comprises:
constructing a target coordinate system matching the perspective of the first user based on the face orientation information of the first user and the first avatar location information of the first user, wherein a direction of one coordinate axis of the target coordinate system is same as a direction indicated by the face orientation information of the first user; and
converting each pixel in the virtual scene to the target coordinate system, and determining a display interface comprising the converted virtual scene.

13. The electronic device according to claim 12, wherein the face orientation information of the first user comprises a pitch angle, a yaw angle and a roll angle of the first user's face in a world coordinate system, and said constructing the target coordinate system comprises:
determining a coordinate origin of the target coordinate system based on the first avatar location information of the first user;
generating a face orientation vector based on the pitch angle and the yaw angle, and determining a first coordinate axis of the target coordinate system based on the face orientation vector;
generating a first direction vector based on the roll angle, and determining a second coordinate axis of the target coordinate system based on the first direction vector; and
generating a second direction vector based on the first direction vector and the face orientation vector, and determining a third coordinate axis of the target coordinate system based on the second direction vector.

14. The electronic device according to claim 13, wherein said converting the each pixel in the virtual scene to the target coordinate system comprises:
generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and
converting the each pixel in the virtual scene to the target coordinate system based on the spatial conversion matrix.

15. A storage medium storing at least one computer program comprising at least one instruction, wherein the at least one instruction, when executed by a processor of an electronic device, causes the electronic device to perform a method comprising:
acquiring a virtual scene corresponding to a user group;
acquiring user information of users in the user group, wherein the user information comprises face orientation information of the users and first avatar location information of the users, the first avatar location information being latest location information of avatars of the users in the virtual scene;
updating display of the avatars of the users in the virtual scene based on the user information;
determining a display interface based on the face orientation information of a first user corresponding to a current electronic device and the first avatar location information of the first user, wherein the display interface comprises a virtual scene with a perspective of the first user as an observation point; and
displaying the display interface.

16. The storage medium according to claim 15, wherein the first user joins the user group by sending image configuration information of the first user, initial avatar location information of the first user, and initial avatar orientation information of the first user to a server.

17. The storage medium according to claim 16, wherein:
the image configuration information of the first user comprises the avatar of the first user and a size of an area occupied by the avatar of the first user;
the initial avatar location information of the first user is determined based on the size of the area occupied by the avatar of the first user, current avatar location information of at least one user in the user group, and a size of an area occupied by the avatar of the at least one user; and
the initial avatar orientation information of the first user is determined based on the initial avatar location information of the first user and the avatar location information satisfying a distance condition; and
wherein the avatar location information satisfying the distance condition is determined in the current avatar location information of the at least one user, and a location indicated by the avatar location information satisfying the distance condition is closest to a location indicated by the initial avatar location information of the first user.

18. The storage medium according to claim 15, wherein said determining the display interface based on the face orientation information of the first user corresponding to the current electronic device and the first avatar location information of the first user comprises:
constructing a target coordinate system matching the perspective of the first user based on the face orientation information of the first user and the first avatar location information of the first user, wherein a direction of one coordinate axis of the target coordinate system is same as a direction indicated by the face orientation information of the first user; and
converting each pixel in the virtual scene to the target coordinate system, and determining a display interface comprising the converted virtual scene.

19. The storage medium according to claim 18, wherein the face orientation information of the first user comprises a pitch angle, a yaw angle and a roll angle of the first user's face in a world coordinate system, and said constructing the target coordinate system comprises:
determining a coordinate origin of the target coordinate system based on the first avatar location information of the first user;
generating a face orientation vector based on the pitch angle and the yaw angle; and determining a first coordinate axis of the target coordinate system based on the face orientation vector;
generating a first direction vector based on the roll angle, and determining a second coordinate axis of the target coordinate system based on the first direction vector; and
generating a second direction vector based on the first direction vector and the face orientation vector, and determining a third coordinate axis of the target coordinate system based on the second direction vector.

20. The storage medium according to claim 19, wherein said converting the each pixel in the virtual scene to the target coordinate system comprises:
generating a spatial conversion matrix based on the first avatar location information, the face orientation vector, the first direction vector and the second direction vector of the first user, wherein the spatial conversion matrix is configured to indicate a conversion relationship between the world coordinate system and the target coordinate system; and
converting the each pixel in the virtual scene to the target coordinate system based on the spatial conversion matrix.
